(19) United States
(12) Patent Application Publication
(10) Pub. No.: US 2022/0388317 A1
(43) Pub. Date: Dec. 8, 2022

(54) LABEL-SENSING METHOD

(71) Applicant: CHIEN-WEN CHANG, Taichung (TW)

(72) Inventor: CHIEN-WEN CHANG, Taichung (TW)

(21) Appl. No.: 17/341,398

(22) Filed: Jun. 8, 2021

(51) Int. Cl. B41J 11/00; B41J 3/407; B65C 9/18

(52) U.S. Cl. CPC B41J 11/0095; B41J 3/4075; B65C 9/1865

(57) ABSTRACT

A label-sensing method includes the steps of aligning a sensor to an exposed portion of a strip of release paper that supports a row of labels, switching the sensor to a setting mode, determining whether an existing threshold is to be used for the roll of labels, transferring an existing threshold to the sensor if an existing threshold is to be used for the roll of labels, using the sensor to scan the exposed portion of the release paper and produce a sensed value if no existing threshold is to be used for the roll of labels, and calculating a threshold based on the sensed value, storing the threshold and transferring the threshold to the sensor.

### BACKGROUND OF INVENTION

### 1. Field of Invention

The present invention relates to a labeling machine and, more particularly, to a label-sensing method for a labeling machine

### 2. Related Prior Art

A labeling machine is used to attach labels to boxes, bottles, cans or the like. Typically, the labels are in the form of stickers supported on a strip of release paper in the form of a roll. There is a gap between any two adjacent ones of the labels so that each of the gaps exposes a portion of the release paper. The labeling machine includes a sensor for sensing the labels. When a leading one of the labels is in a desired position, the leading label is detached from the release paper and attached to a leading one of the boxes, bottles, cans or the like.

The sensor senses the labels because the transmittance of the labels is different from the transmittance of the release paper. The labeling machine includes a knob or buttons operable to set a threshold for the transmittance. What is sensed by the sensor is determined to be a label when the transmittance is lower than the threshold. What is sensed by the sensor is determined to be an exposed portion of the release paper when the transmittance is higher than the threshold.

Ideally, the labels in a same roll exhibit identical transmittance. However, in practice, the labels on the same roll exhibit slightly different transmittances. For each roll of labels, an operator has to use the sensor to sense one of the exposed portions of the release paper and use the knob or buttons to set a threshold. However, this process has to be repeated several times on others of the exposed portions of the release paper to ensure that the sensor transmits a first signal (“ON”) when sensing each of the labels or a second signal (“OFF”) when sensing each of the exposed portions of the release paper.

However, the threshold has to be determined for each roll of labels. That is, the threshold has to be set multiple times for multiple rolls of labels even if the rolls of labels are of a same sort. This practice is a waste of time.

The present invention is therefore intended to obviate or at least alleviate the problems encountered in prior art.

### SUMMARY OF INVENTION

It is the primary objective of the present invention to provide a label-sensing method to be executed in a labeling machine.

To achieve the foregoing objective, the label-sensing method comprising the steps of aligning a sensor to an exposed portion of a strip of release paper that supports a row of labels, switching the sensor to a setting mode, determining whether an existing threshold is to be used for the roll of labels, transferring an existing threshold to the sensor if an existing threshold is to be used for the roll of labels, using the sensor to scan the exposed portion of the release paper and produce a sensed value if no existing threshold is to be used for the roll of labels, and calculating a threshold based on the sensed value, storing the threshold and transferring the threshold to the sensor.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a block diagram of a label-sensing method for a labeling machine according to the preferred embodiment of the present invention.

### DETAILED DESCRIPTION OF PREFERRED EMBODIMENT

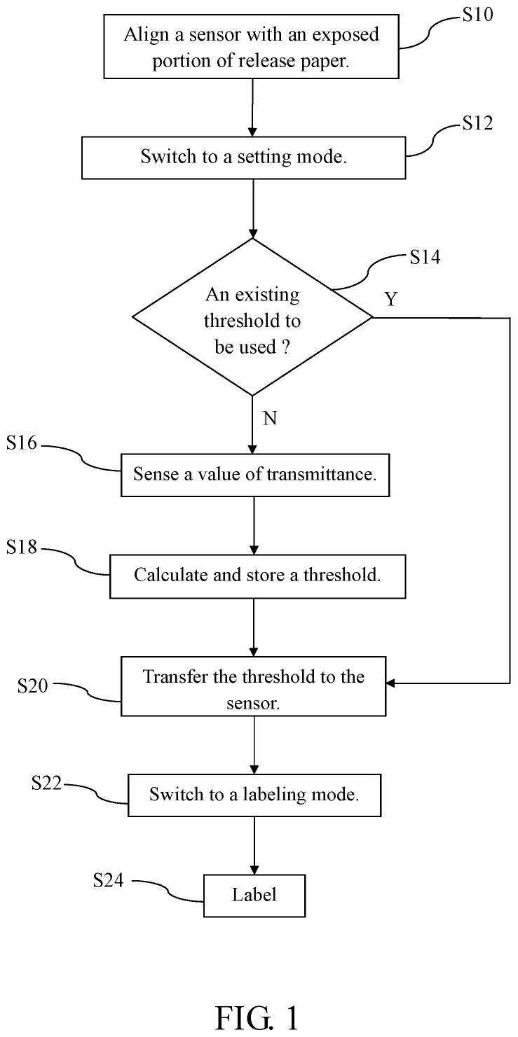

Referring to FIG. 1, there is shown a label-sensing method according to the preferred embodiment of the present invention. The label-sensing method can be executed in a labeling machine (not shown) including a controller electrically connected to a sensor and a feeder. The labeling machine is used to handle a roll of labels as described above in the RELATED PRIOR ART.

At S10, the sensor is aligned with one of the exposed portions of the release paper.

At S12, the labeling machine is switched to a setting mode.

At S14, it is determined whether a threshold existing in the controller is to be used for the present roll of labels. The process goes to S20 if any an existing threshold is to be used for the present roll of labels or S16 if otherwise.

In specific, an existing threshold is to be used for the present roll of labels if there is a previous roll of labels identical to the present roll of labels. No existing threshold is to be used for the present roll of labels if there is not any previous roll of labels identical to the present roll of labels.

At S16, preferably, the sensor is used to scan at least one of the exposed portions of the release paper and accordingly produce at least one sensed value of transmittance as the labeling machine is in the setting mode. Alternatively, the sensor is used to scan at least one of the exposed portions of the release paper and at least one of the labels and accordingly produce at least two sensed values of transmittance.

At S18, a threshold is calculated and stored. Preferably, an algorithm is executed in the controller to calculate the threshold based on the sensed value. Then, the threshold is stored in the controller.

At S20, the threshold is transferred to the sensor. The threshold comes from the controller in which the threshold is calculated or stored. The threshold is to be used for the present roll of labels.

At S22, the labeling machine is switched to a labeling mode. The labeling machine transmits a first signal when the sensor senses each of the labels, i.e., the sensed value is smaller than the threshold. The labeling machine transmits a second signal when the sensor senses each of the exposed portions of the release paper, i.e., the sensed value is larger than the threshold.

At S24, the threshold is used in labeling. On determining that a leading one of the labels is in a desired position, the controller stops the feeder from feeding the roll of labels. Then, the controller instructs the labeling machine to transfer the leading label to a box, bottle, can or the like from the release paper. While determining that the leading label is not in the desired position, the controller continues to instruct the feeder to feed the roll of labels.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A label-sensing method comprising the steps of:
aligning a sensor to an exposed portion of a strip of release paper that supports a row of labels;
switching the sensor to a setting mode;
determining whether an existing threshold is to be used for the roll of labels;
transferring an existing threshold to the sensor if an existing threshold is to be used for the roll of labels;
using the sensor to scan the exposed portion of the release paper and produce a sensed value if no existing threshold is to be used for the roll of labels; and
calculating a threshold based on the sensed value, storing the threshold and transferring the threshold to the sensor.

2. The method according to claim 1, comprising the step of switching to a labeling mode after transferring the threshold to the sensor.
